(19) United States
(12) Patent Application Publication
(10) Pub. No.: US 2007/0071225 A1
(43) Pub. Date: Mar. 29, 2007

(54) Remote time based accountability system

(76) Inventor: Juliet D. Leyland, Citrus Heights, CA (US)

Correspondence Address: LITMAN LAW OFFICES, LTD, PO BOX 15035, CRYSTAL CITY STATION, ARLINGTON, VA, 22215, US

(21) Appl. No.: 11/489,490

(22) Filed: Jul. 20, 2006

Related U.S. Application Data
(60) Provisional application No. 60/702,662, filed on Jul. 27, 2005.

(51) Int. Cl. H04M 3/00; H04M 5/00

(52) U.S. Cl. 379/265.06

(57) ABSTRACT

The present invention is a method for operating a remote time based accountability system comprising the steps of receiving and storing information from a non-automated communication from a user, determining an emergency services contact telephone number based on receiving and storing information from the communication, generating a schedule based on the receiving and storing information from the communication from the user, determining if any new non-automated communication is received from the user before the expiration of the schedule, and performing a calling routine based on determining if any new communication has been a received from the user.

### CROSS-REFERENCE TO RELATED APPLICATION

This application claims the benefit of U.S. Provisional Patent Application Ser. No. 60/702,662, filed Jul. 27, 2005.

### BACKGROUND OF THE INVENTION

1. Field of the Invention

The present invention relates to a system and method for operating a remote time based accountability system, more particularly to an automated telephone-based calling system capable of created a schedule from a user's input, monitoring if the user has checked back in with the system before the expiration of the schedule, and notifying third parties when the user has not properly notified the system based on the user input schedule.

2. Description of the Related Art

The prior art teaches many systems for tracking the geographical position and travels of individuals and mobile objects through the use of various technologies, primarily Global Positioning System (GPS) technology.

However, there exists a need for a much less technologically advanced and more cost effective solution for remotely and independently triggering alerts for individuals who need an independent accountability checking system over a period of time, or over both a period of time and a location.

Commonly known residential and commercial alarm systems remotely monitor premises by receiving alert signals from sensors located on a premises. However, such systems cannot be modified to determine if an individual has taken their medication before a predetermined time, or has arrived at a destination by a certain time.

Even though telephone systems with remotely accessed digital answering systems may alert the subscriber at a remote location of recently received voice mail messages, they are not currently designed to act as an alarm system that is set up by a user who wishes the system to automatically call a predetermined list of individuals or emergency services if the user fails to check in with the system by a certain time or at a certain location.

The need for a system to act as a remotely activated and automatic “alarm clock” when a user sets the system to look for the user's response within a scheduled period of time set by the user has long existed. The benefits for such a system would assist the safety and confidence of many people who live or travel alone and want certain individuals, i.e., family members, health care providers, convalescence care providers, emergency services providers, etc., to be notified in circumstances where they do not check back in with the remote accountability system within their scheduled period of time.

Thus, a remote time based accountability method and system solving the aforementioned problems is desired.

### SUMMARY OF THE INVENTION

The present invention is a method for operating a remote time based accountability system comprising the steps of receiving and storing information from a non-automated communication from a user, determining an emergency services contact telephone number based on receiving and storing information from the communication, generating a schedule based on the receiving and storing information from the communication from the user, determining if any new non-automated communication is received from the user before the expiration of the schedule, and performing a calling routine based on determining if any new communication has been a received from the user. It should be noted that the term “non-automated” is intended to mean that the communications must be initiated by the user and is not automatically generated by a GPS or other system. In this manner, the activity of the user is positively verified.

The communication received from the user may be over a landline telephone network, a cellular telephone network or a computer network, and it identifies the user to the remote time based accountability system.

The communication from the user also may comprise a list of contact telephone numbers that the system will automatically call in the event the user fails to notify the system within the scheduled time period. Additionally, the communication may further comprise a personal emergency contact telephone number to be used in the alternative of contacting an emergency services provider.

The step of determining the emergency services contact telephone number may be based on an identified location made by the user or user identified locations of an origin and destination of travel of the user.

Additionally, the information from the communication from the user may further include a total elapsed time starting from the time of receiving the communication from the user, a single target time for a specific day, and a schedule of target times for a specific day or for multiple days. The information may also include identified locations of an origin and destination of travel of the user that may be input as either a general location or a specific address.

The calling routine of the system includes calling via a telephone network a first telephone number on a predetermined list of contact telephone numbers. If no person is contacted to give a response, the system will then call via a telephone network a second telephone number on the predetermined list of contact telephone numbers. The system may call via a telephone network a personal emergency contact telephone number in the alternative to calling an emergency services telephone number when the accountability system fails to contact any person from the predetermined list of contact telephone numbers.

The system may determine the location of the user based on receiving a confirmation communication from the user based on recognizing information transmitted with a landline telephone call, a cellular telephone call, or information transmitted from an Internet service provider (ISP). It should be noted that the system can be accessed and activated using any telecommunications device.

These and other features of the present invention will become readily apparent upon further review of the following specification and drawings.

### BRIEF DESCRIPTION OF THE DRAWINGS

Other objects of this invention will appear in the following description and appended claims, reference being made to the accompanying drawings forming a part of the specification where in like reference characters designate corresponding parts in the several views.

FIG. 1 is a block diagram of a remote time based accountability system.

FIG. 2 is a listing of information input by the user into the system of the present invention.

FIG. 3 is a logical flowchart diagram of the method of the present invention.

### DETAILED DESCRIPTION OF THE PREFERRED EMBODIMENTS

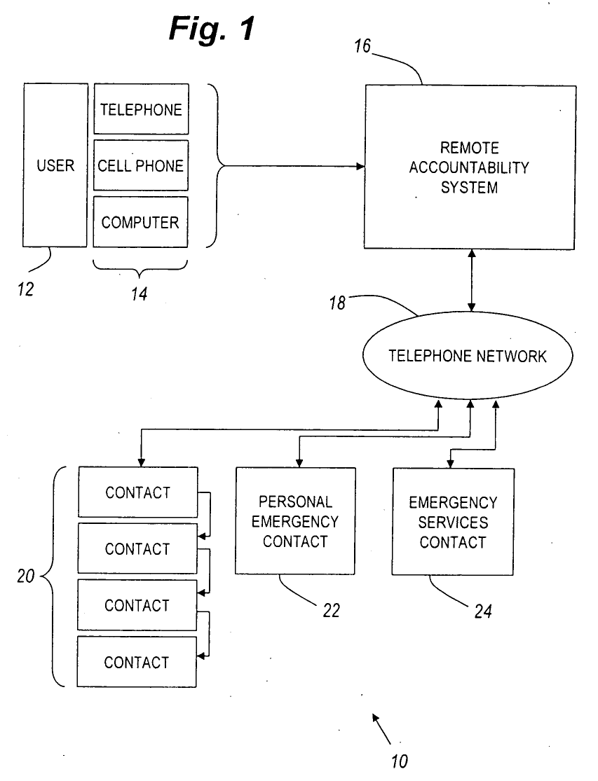

In describing the present invention, reference will be made herein to FIGS. 1-3 of the drawings in which like numerals refer to like features of the present invention.

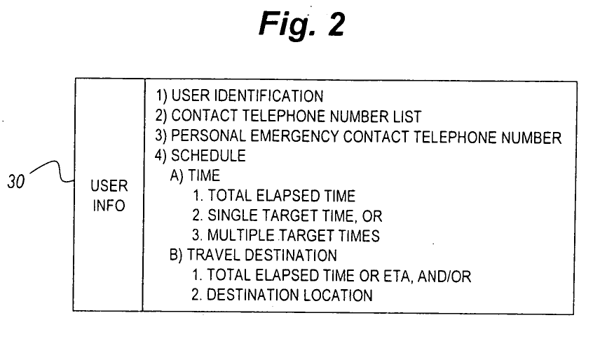

FIG. 1 is a block diagram of the remote time based accountability system 10 on which an embodiment of the present invention can be performed. A user 12 communicates via a landline telephone network, a cellular telephone network, or a computer network (or any other capable communication means, generally 14) with the remote accountability system 16. The user 12 inputs, or may be prompted by the remote accountability system 16 to input information regarding setting up the automated accountability system. FIG. 2 illustrates the user information 30 that may be input to the remote accountability system 16. The user 12 inputs their unique user identification to the system for tracking and/or billing purposes. Next, the user 12 inputs a contact telephone number list of people who will be called, in order, if the user fails to notify the system within a schedule period of time. Optionally, the user 12 may input a personal emergency contact telephone number for the remote accountability system 16 to contact if the user chooses to not have an emergency services contact telephone number.

Then the user 12 may choose from two different scheduling scenarios. First, the user 12 may choose a period of time with which the remote accountability system 16 will be activated. This period of time may be a total elapsed time measured from the user's initial communication, a single target time, that is, a time of day, or multiple target times within a single day or over multiple days.

Second, the user 12 may choose a travel destination scenario by inputting a total elapsed period of travel time or an estimated time of arrival. Additionally, user 12 may input a destination location by including either a general area of the destination or a specific address.

In addition to the above information, the user and any of those put on the contact list by the user, can input a message. These messages may be coded or simply recorded depending on the user's selection. For example: a code 111 could be indicative of the phrase “I'm OK!”; and code 222 could represent “I am too!”

The remote accountability system 16 is capable of generating an emergency services contact telephone number based on information received from the user 12. The user unique identification may be linked to an account with an address to which the system will locate emergency services contact telephone numbers. Additionally, under the travel destination scenario, the remote accountability system 16 is further able to locate emergency services contact telephone numbers based on the user's input destination location and the origination location of the user.

After the user 12 has input all the appropriate information into the remote accountability system 16, the system generates a schedule based on the time the user specifies in the time scenario or the time and destination location specified in a travel destination scenario.

As the completion time of the schedule approaches, the remote accountability system 16 analyzes all incoming communication to determine if any communication is received by the user 12 having the same user identification as previously input. If communication is received by the user 12 by any communication means compatible with the remote accountability system 16, the system stores a record of the received user communication and is able to communicate information of the receipt of the user communication to a predetermined contact person or to a communication medium, e.g., an e-mail, text message, fax, etc.

If the schedule expires and the remote accountability system 16 determines that there has been no communication from the user 12 within the schedule period of time, a remote accountability system 16 communicates via a telephone network 18 to a contact telephone number in the contact telephone number list 20 as previously provided by user 12. The remote accountability system will only validate a response from a person answering the contact telephone number by either a voice answer recognizable by the remote accountability system 16, or a keyed entry response from the keypad of the telephone in response to a query from the remote accountability system 16. If the remote accountability system 16 fails to receive a valid response from a person answering its call, the system will attempt to call the next contact telephone number on the list, and repeat this process throughout all the telephone contact numbers on the list until a valid response from a person is received. If a person is contacted, the system will provide information about the user 12, the user's schedule details, and information regarding the failure of the user to verify with the remote accountability system within the scheduled time.

If the remote accountability system 16 fails to receive a valid response from any person from the contact telephone number list, the system may call via the telephone network 18 the personal emergency contact 22 as previously specified by user 12. Otherwise, the system will call via telephone network 18 the predetermined emergency services contact number 24 and provide information about the user 12, the user's schedule details, and information regarding the failure of the user to verify with the remote accountability system within the scheduled time.

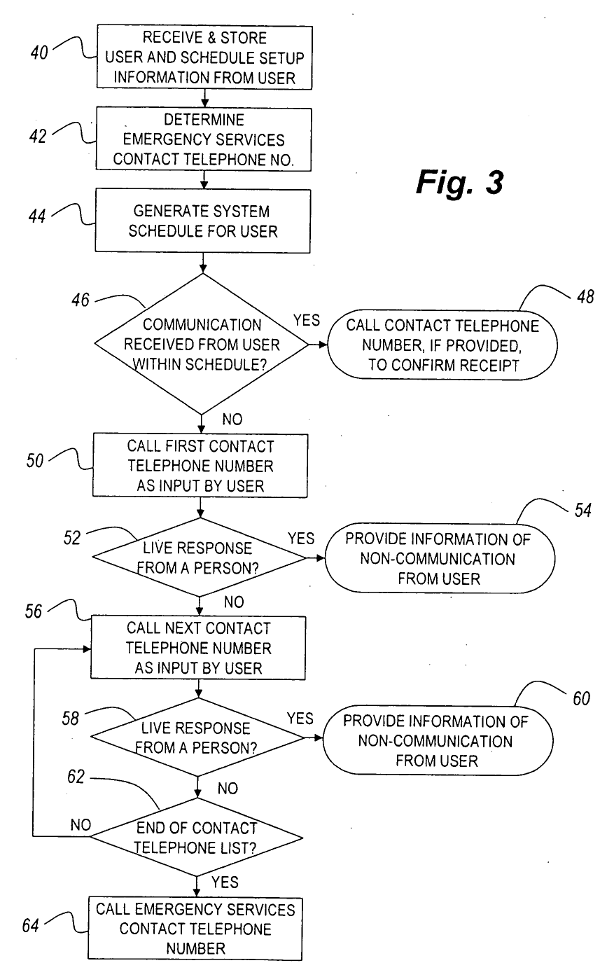

FIG. 3 illustrates a flowchart of the method of the present invention. User 12 provides an initial non-automated communication to the remote accountability system 16 by various communication means and provides user information relating to a user schedule that is received and stored by the remote accountability system 16 at block 40. The remote accountability system 16 determines an emergency services contact telephone number based on the information provided by the user at block 42. The remote accountability system 16 then generates a user specific schedule based on information provided by the user at block 44. The remote accountability system 16 determines if any communication is received from the user 12 associated with the user schedule before expiration of the schedule at block 46. If communication is received from user 12, the system records such communication and may call a contact telephone number if provided by the user 12 to confirm receipt of user communication within the scheduled period of time at block 48.

If no communication is received from a the user 12 before the expiration period of the schedule, the system contacts the first telephone number of the contact telephone number list as input by the user at block 50. The system then waits for a response and determines if a person answers the telephone call from the system at block 52. If a response is given that indicates a person has received a telephone call, the remote accountability system 16 notifies the contacted person that no communication was received from the user 12 within the schedule period of time at block 54. If the system determines that no person answers the telephone call, the system calls the next contact telephone number as input by the user at block 56. Again, the system waits for a response and determines if a person answers a telephone call from the system to which it will provide information of no communication received from the user 12 within the schedule period of time at block 60. If the system determines that no person answers the telephone call, the system continues to call each contact telephone number until it has finished calling the last contact telephone number at block 62.

Once the last contact telephone number is determined by the remote accountability system 16 to have no response from any person, the system then calls the emergency services contact telephone number at block 64 with information of the specific user, the user's schedule and the failure of the user to contact remote accountability system within the time period of the schedule.

An alternative embodiment of the present invention anticipates the remote accountability system 16 being able to determine a specific location from a user arriving at a specific destination. For example, once the user arrives at a destination that has been input previously to the remote accountability system 16 before travel, the user may communicate with remote accountability system 16 via a telephone or cellular telephone network. The remote accountability system 16 is able to determine the location of the incoming telephone call based on a general location data transmitted with the telephone call. Additionally, if the user communicates with remote accountability system 16 via a computer over the Internet, the remote accountability system 16 is able to determine the general location of the incoming data transmission based on Internet service provider (ISP) data transmitted with the user communication. This may facilitate an additional feature to the present invention wherein the system is able to notify contact telephone numbers or a personal emergency contact as designated by the user if the user communicates with the remote accountability system outside of the original user specified travel destination.

It is to be understood that the present invention is not limited to the embodiments described above, but encompasses any and all embodiments within the scope of the following claims.

I claim:

1. A method for operating a remote time based accountability system comprising the steps of:
receiving and storing information from an initial non-automated communication from a user;
determining at least one contact telephone number based on said step of receiving and storing information from said communication;
generating a schedule based on said receiving and storing information from said communication from said user;
determining if any new non-automated communication is received from said user before the expiration of said schedule; and
performing a calling routine to said at least one contact telephone number based on said step of determining if any new non-automated communication has been a received from said user.

2. The method of claim 1 wherein said determining if any new non-automated communication is received step determines that a new non-automated communication has been received, and said performing a calling routine step comprises confirming receipt of said new non-automated communication to said at least one contact telephone number.

3. The method of claim 1 wherein said determining if any new non-automated communication is received step determines that a new non-automated communication has not been received, and said performing a calling routine step comprises providing information regarding the failure of the user to verify with the remote time based accountability system to said at least one contact telephone number.

4. The method of claim 3 wherein said information comprises the user's destination location.

5. The method of claim 1 wherein said at least one contact telephone number comprises a plurality of contact telephone numbers.

6. The method of claim 5 wherein said step of performing a calling routine comprises calling each of said plurality of contact telephone numbers until a valid response is received.

7. The method of claim 5 wherein said plurality of contact telephone numbers further comprises a personal emergency contact.

8. The method of claim 7 wherein said step of performing a calling routine comprises calling each of said plurality of contact telephone numbers until a valid response is received, and in the event a valid response is not received, said personal emergency contact is called.

9. The method of claim 5 wherein said plurality of contact telephone numbers further comprises an emergency services contact.

10. The method of claim 9 wherein said step of performing a calling routine comprises calling each of said plurality of contact telephone numbers until a valid response is received, and in the event a valid response is not received, said emergency services contact is called.

11. The method of claim 1 wherein said non-automated communications are received via a landline telephone network.

12. The method of claim 1 wherein said non-automated communications are received via a cellular telephone network.

13. The method of claim 1 wherein said non-automated communications are received via a computer network.

14. The method of claim 1 wherein said non-automated communications comprises a unique user identification.

15. The method of claim 1 wherein said schedule is based on a total elapsed time since said initial non-automated communication.

16. The method of claim 1 wherein said schedule is based on a single target time.

17. The method of claim 1 wherein said schedule is based on multiple target times.

18. The method of claim 1 wherein said information comprises the user's destination location and said schedule is based on an estimated time of arrival.

19. The method of claim 1 wherein said information comprises the user's destination location and said schedule is based on said destination location.
